(19) United States
(12) Patent Application Publication
(10) Pub. No.: US 2005/0256788 A1
(43) Pub. Date: Nov. 17, 2005

(54) Apparatus and method for tracking products

(76) Inventor: Syunichi Mukai, Fujisawa-shi (JP)

Correspondence Address: IBM CORPORATION;INTELLECTUAL PROPERTY LAW, 11400 BURNET ROAD, AUSTIN, TX, 78758, US

(21) Appl. No.: 11/126,123

(22) Filed: May 10, 2005

(30) Foreign Application Priority Data
May 11, 2004 (JP) 2004-141005

(51) Int. Cl. G06F 17/60

(52) U.S. Cl. 705/29

(57) ABSTRACT

Tracking products to be recalled to find the product serial number of a defective product and the faulty parts or process that caused the defect. Data is collected by tracing selected parts (TP) and stored in databases. A trace engine consults the process definition DB to identify a process in which the faulty parts were used, the TP history DB to determine the transit time at which the TP used in the product in question passed through the process, the process control DB to identify the TP-IDs of the other TP that passed through the process in the same time frame as the transit time determined, and the TP history DB to determine the serial numbers of all products using the TP.

### TECHNICAL FIELD

The present invention relates to a product tracking apparatus or the like with which, when a defective product piece is found, other pieces of the product that have the same defect are tracked.

### DESCRIPTION OF RELATED ART

When a defect occurs in a product such as a car, a recall of the defective product, for example, will be carried out. If the serial number of the defective product and faulty parts are found, the recall will need to be done on all product pieces determined to use parts from the same lot as the faulty parts. On the other hand, if the serial number of the defective product and a process in which the defect occurred are found, the recall will need to be done on all product pieces determined to have undergone, or passed through, the process during the time period for which the process was defective.

Under the existing conditions, product pieces to be recalled are manually identified by tracking product serial numbers, part serial numbers, or worksheets.

On the other hand, the management of bills of materials, each showing the relationship between a product and components making up the product (for example, Japanese patent laid-open application No. 2001-255926 (pages 1 and 2 of the specification, and FIG. 2)) and the management of process information concerning working hours and process contents in the manufacture of the product (for example, Japanese patent laid-open application No. 07-239878 (pages 12 and 13 of the specification, and FIG. 15)) have conventionally been carried out.

However, the inventions described in these patent documents do not aim to manage the information for the purpose of identifying product pieces to be recalled. Therefore, they cannot solve the following problems caused by manually identifying product pieces to be recalled.

The first problem is that the recall list will probably include non-defective product pieces because there is no other way but to recall all product pieces suspected of being defective, such as product groups being manufactured in the same month or suspected of using components from the same lot. 100 percent tracking is impossible at manual work based on information such as manufacture records.

The second problem is that manual tracking requires a lot of time and manpower because the way of manually tracking records varies from person to person.

To solve these problems, one possible solution is to record the serial numbers or lot numbers of all parts used in the manufacture of each product, and meanwhile, to record the lot number of parts assembled in each process or work conditions in the process. This solution may work in theory but not in practice. For example, since auto-parts amount to about 30,000 pieces, recording the lot number of parts or the like each time one of the parts is assembled is economically impractical.

### SUMMARY OF THE INVENTION

The present invention has been made to solve the above-mentioned technical problems, and it is an object thereof to improve the success rate of tracking product pieces to be recalled under such condition that the serial number of a defective product and parts or a process that caused the defect are found.

It is another object of the present invention to improve the success rate of tracking efficiently without collecting information on all the components of the product.

To attain the objects, according to the present invention, particular ones of multiple parts are predetermined as a part (traced part) used for future tracking of a particular product made up of the multiple parts, and information on the traced part is collected in each manufacturing process. In other words, in the first aspect of the present invention, there is provided an apparatus including a first recording unit for recording identification information on each traced part and the time at which each traced part passed through a particular process for manufacturing a product, and a second recording unit for recording identification information on each product using each traced part in association with the information on the traced part. In this first apparatus, a functional feature for use in recording the information on each traced part is considered the first recording unit, while a functional feature for use in recording the information on each product by linking it to the information on each traced part is considered the second recording unit. In the specification, the term “passing time” or “transit time” includes situations that mean a certain time frame.

The present invention can also take the form of an apparatus for tracking products to be recalled by referring to the collected information on each traced part. In other words, in the second aspect of the present invention, there is provided an apparatus including a first database storing first information for identifying traced parts for each product, a second database storing second information for identifying each traced part passing through each process for manufacturing the product and its transit time, traced part identifying means for identifying a traced part passing through a particular process in a particular time frame by referring to the second information stored in the second database, and product identifying means for identifying particular products manufactured using the traced part identified by the traced part identifying means from the first information stored in the first database.

The present invention can further take the form of a traced part decision device for deciding on a particular component to be a traced part for a particular product. In this case, the traced part decision device according to the present invention includes a binary tree information storing unit, a node group selecting unit, and a leaf selecting unit. The binary tree information storing unit stores first information for identifying multiple leaves corresponding to multiple components of the product in a binary tree in which a completed product defined as the root, and second information for identifying multiple node groups corresponding to respective processes for manufacturing the product. The node group selecting unit selects a node group having the greatest number of nodes, after counting the number of node groups, through which each of the multiple node groups identified from the second information stored in the binary tree information storing unit goes to the root. The leaf selecting unit selects, as a leaf corresponding to a traced part, any one of leaves connected to the node group selected by the node group selecting unit.

Furthermore, the present invention can take the form of a method of tracking products to be recalled, in such a way as to predetermine particular ones of multiple parts as a part (traced part) used for future tracking of a particular product made up of the multiple parts. In this case, the method according to the present invention includes: a step of storing, in a first database, first information for identifying traced parts for each product; a step of storing, in a second database, second information for identifying each traced part passing through each process for manufacturing the product and its transit time; a step of identifying a traced part passing through a particular process in a particular time frame by referring the second information stored in the second database; and a step of identifying particular products manufactured using the identified traced part by referring to the first information stored in the first database.

In addition, the present invention can take the form of a program for allowing a computer to implement predetermined functions.

### BRIEF DESCRIPTION OF THE DRAWINGS

FIG. 1 is a pictorial illustration showing processes for manufacturing a product to which a preferred embodiment of the present invention is applied.

FIG. 2 is a diagram for explaining an ABT used in the embodiment of the present invention.

FIG. 3 is a diagram for explaining the ABT used in the embodiment of the present invention in relation to the time axis.

FIG. 4 is a diagram for explaining TP defined in the ABT and how to merge TP in the embodiment of the present invention.

FIG. 5 is a diagram showing an example of TP history information according to the embodiment of the present invention.

FIG. 6 is a diagram showing an example of process control information according to the embodiment of the present invention.

FIG. 7 is a block diagram showing the functional structure of a product tracking apparatus according to the embodiment of the present invention.

FIG. 8 is a block diagram showing the functional structure of a trace engine according to the embodiment of the present invention.

FIG. 9 is a diagram for explaining Case 1 in the embodiment of the present invention.

FIG. 10 is a flowchart showing the operation of the product tracking apparatus in Case 1 according to the embodiment of the present invention.

FIG. 11 is a diagram for explaining Case 2 in the embodiment of the present invention.

FIG. 12 is a flowchart showing the operation of the product tracking apparatus in Case 2 according to the embodiment of the present invention.

FIG. 13 is a diagram for explaining Case 3 in the embodiment of the present invention.

FIG. 14 is a flowchart showing the operation of the product tracking apparatus in Case 3 according to the embodiment of the present invention.

FIG. 15 is a diagram for explaining how to represent, in binary format, parts and processes placed in the ABT according to the embodiment of the present invention.

FIG. 16 is a block diagram showing the functional structure of a TP decision device according to the embodiment of the present invention.

FIG. 17 is a flowchart showing the operation of the TP decision device according to the embodiment of the present invention.

FIG. 18 is a block diagram showing the hardware structure of each apparatus or device according to the embodiment of the present invention.

### DETAILED DESCRIPTION OF THE PREFERRED EMBODIMENT

Effect of the Invention

According to the present invention, the success rate of tracking products to be recalled is improved under such condition that the serial number of a defective product and a faulty component or process that caused the defect are found.

The best mode for carrying out the present invention (hereinafter called the “embodiment”) will be described in detail below with reference to the accompanying drawings.

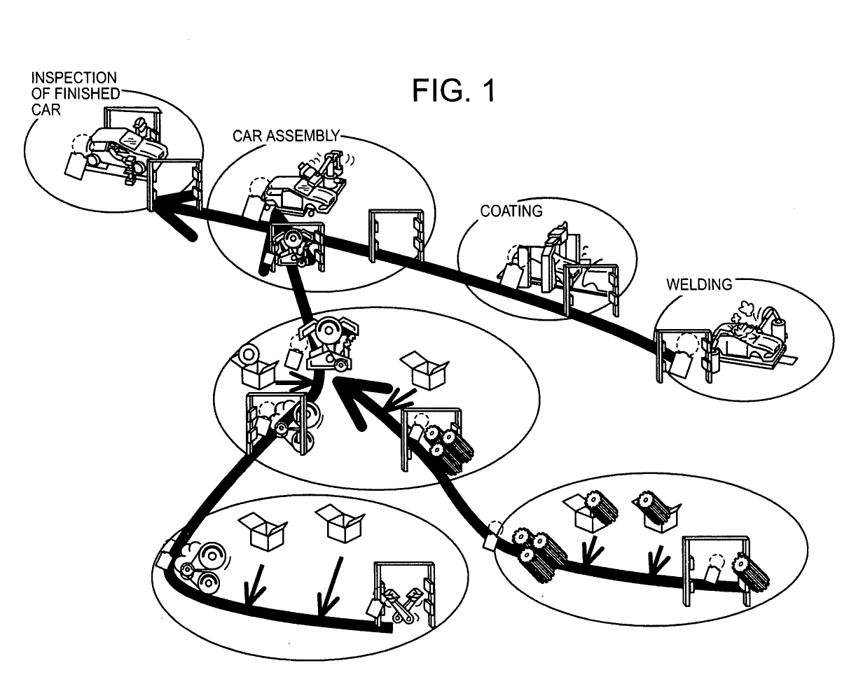

In the embodiment, it is assumed that a product like a car is manufactured through processes (manufacturing process) as shown in FIG. 1. As shown in FIG. 1, the manufacturing processes may not be linear in general. In other words, the assembly of parts is made in parallel with welding and coating of car bodies, and the parts are assembled into each car body in a car assembly process. After that, the inspection of each finished car is conducted as the final process.

The flow of manufacturing a product can be represented in an abstract form in an assembly binary tree (hereinafter called the “ABT”).

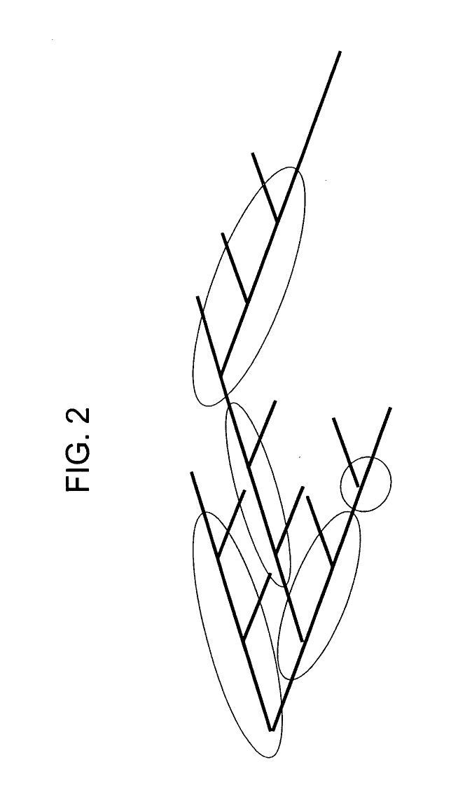

FIG. 2 shows an example of the ABT. In this example, a binary tree defining a completed product as the root and each part as a leaf represents the process of manufacturing a finished product while assembling all parts. In an actual situation, there may be a case where three parts are assembled into one basic component in one operation. Even in such a case, priorities are assigned to them in the binary tree from a microscopic point of view or for convenience sake.

Each intersection in the binary tree, called a “junction,” means that two parts become united. Each step of the manufacturing procedure, called a “process,” is enclosed with an ellipse in FIG. 2. In such a binary tree, one junction may constitute one process, or two or more junctions may constitute one process. In FIG. 2, one process is always represented as one junction or a series of junctions. The term “junction” corresponds to every node.

Incidentally, the ABT is different from the bill of materials (hereinafter called the “BOM”). To be specific, the following points are different:

First, the BOM describes the relationship between principal and accessory, while the ABT describes the order of assembling of all parts.

Second, when there are two or more sub-parts for one main part, the BOM does not describe the order of assembling of the sub-parts. On the other hand, the ABT describes the order of assembling of all parts.

Third, sub-parts belonging to different main parts are placed away from each other in the BOM. On the other hand, if the sub-parts are preassembled in a particular process, the ABT will describe them according to the order of assembly.

In other words, the ABT describes the actual order of assembly based on the assembly process settings and information on parts structure.

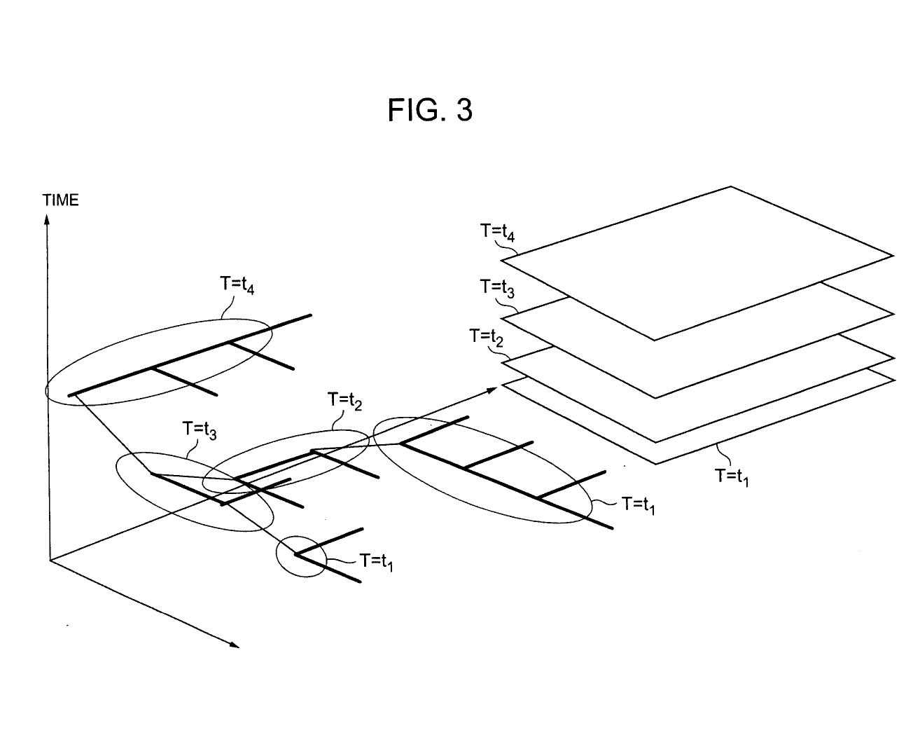

FIG. 3 shows each assembly process in the ABT of FIG. 2 along the time axis. Assumed that one process is finished in a short time, each process is represented on a plane perpendicular to the time axis (as partially indicated on the right side of the graph). Specifically, two processes are performed at time T=t1, the next process at time T=t2, the next process but one at time T=t3, and the final process at time T=t4 (where t1<t2<t3<t4). Thus any upstream assembly process is always located on the downside (past side) of the immediately downstream assembly process with respect to the time axis. Note here, however, that the time to perform each process varies from a process to a process.

Although FIG. 3 shows the chronological order of processes for finishing a piece of a single product, the chronological order of processes for finishing multiple pieces of a single product is generally not so simple. For example, even though four product pieces A, B, C, and D were finished in this order, their semifinished components might have not been assembled in this order in the processes passed through up to completion of the product. This is because semifinished components are not always used for assembly of A, B, C and D in the order of manufacture. In other words, they are used for the convenience of transportation or depending on the availability of stock, not in the order of manufacture of the components. Further, if there are two or more lines in one process, the four pieces may not be assembled in the same line.

It is generally considered that the order of assembling each of the four pieces in a certain process is totally independent of the order of parts assembled in the first process, or the order of completion of each product piece. Suppose here that a product piece is found to be defective. In this case, even after the serial number of the product and faulty parts are determined, it is difficult to identify other product pieces using parts from the same lot as the faulty parts. On the other hand, even after the serial number of the product and a faulty process are determined, it is also difficult to identify other product pieces having undergone, or passed through, the process during the time period for which the process was defective.

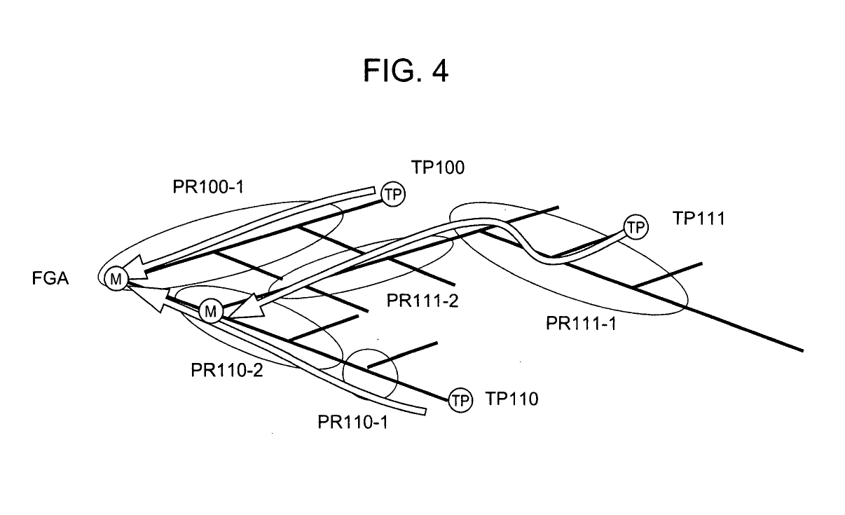

Therefore, the present invention is to reconsider the ABT of a product to introduce a new idea. In other words, as shown in FIG. 4, the present invention is to define TP (Traced parts) for leaves that are end-nodes of the ABT. In FIG. 4, a “circle” is drawn around the abbreviation “TP” to represent each TP.

As indicated by a hollow arrow in FIG. 4, TPs are difined so that all the processes are passed through by at least one TP in the ABT. Or additional TPs can be added further. Each TP is selected by taking into account other practical conditions, such as whether it is easy to attach and detect a bar code or RFID (Radio Frequency Identification). Further, essentially important parts, that is, those that need to be managed by individual serial numbers, may be given priorities as TP. For example, they are parts like those used in the mainframe of a car engine.

The parts defined as TP are assigned a serial number for identifying each piece of TP (hereinafter called the “TP-ID”). The serial number is traced by reading the bar code or RFID from the first stage of assembly. If it is difficult to attach the bar code or RFID on each part, it may be managed as a tag attached to each part.

The present invention also provides another novel idea, that is, merging TP.

As the assembly process progresses, a case may occur where two TP are assembled into one semifinished component in a certain process. In this case, one of the TP, defined as slave TP, is absorbed into the other, defined as master TP. To be more specific, a link between the TP-ID of the master TP and the TP-ID of the slave TP is recorded so that only the master TP will be traced in subsequent (downstream) assembly processes. Once these TP are assembled into a semifinshed component and their relationship is recorded, one representative TP has only to be traced. This process of merging TP is called PT merger. In FIG. 4, each merger node is represented by drawing a “circle” around the letter “M.”

Then, information as to which part is associated with each end of the ABT, and information as to which process is associated with each combination of junctions in the ABT are stored in a predetermined storage device as process definition information.

Information for describing to which lot each piece of TP belongs is also stored in the predetermined storage. In other words, correspondences between TP-IDs and lot numbers are stored.

The following describes a method of recording TP history information indicating which TP passed through each process shown in FIG. 4. It is assumed here that three TP are defined. Individual pieces of information for identifying each of the TP as a part (hereinafter called the “parts information”) is named “TP100,” “TP110,” and “TP111,” respectively. It is also assumed that the number of processes is five. Individual pieces of information for identifying each process (hereinafter called the “process information”) is named “PR100-1,” “PR110-1,” “PR110-2,” “PR111-1,” and “PR111-2,” respectively.

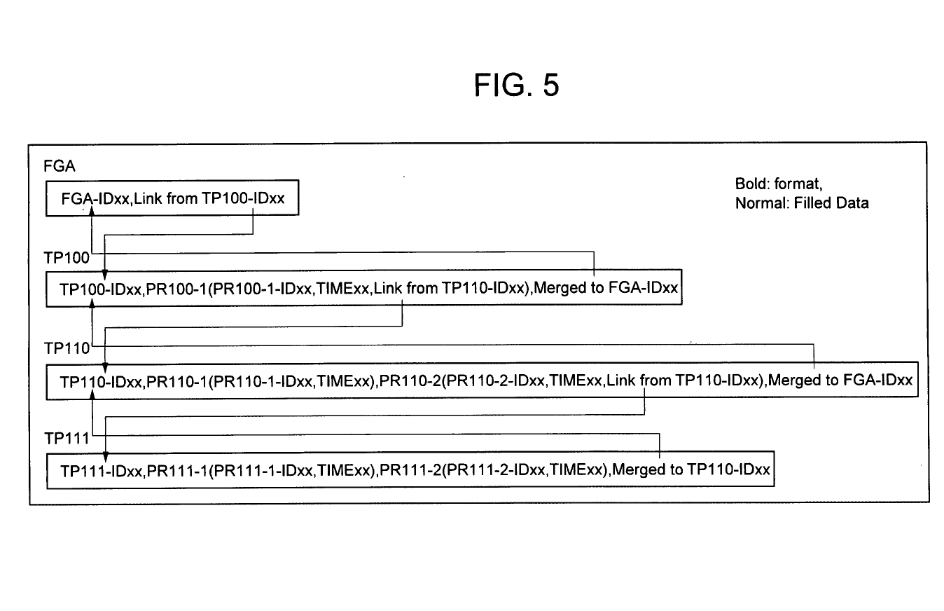

FIG. 5 shows, though not limited to, the structure of TP history information.

The history information is created as follows:
1) At the time of assembling the TP “TP111,” its TP-ID “TP111-IDxx” is recorded.

2) As information on the process in which the TP “TP111” was assembled, the process ID “PR111-1-IDxx” and the time “TIMExx” at which the TP passed through the process are recorded as TP-ID “TP111-IDxx” records. The process ID is information for identifying a process line through which the TP actually passed when there are two or more lines in one process. The time information “TIMExx” may include exact time data or identification symbols indicating a particular time frame.
3) When a semifinished part manufactured in the process “PR111-1” is assembled in the process “PR111-2,” the process ID “PR111-2-IDxx” and the time “TIMExx” are added to the TP-ID “TP111-IDxx.”
4) On the other hand, when the TP “TP110 is assembled independently of the cases laid down in the above items 1), 2), and 3), the TP-ID “TP110-IDxx” is created as a record.
5) After that, as information on the process “PR110-1,” the process ID “PR110-1-IDxx” and the time “TIMExx” at which the TP passed through the process are recorded as TP-ID “TP110-IDxx” records.
6) In the process “PR 110-2,” two semifinished parts encounter each other. Therefore, the TP with the TP-ID “TP111-IDxx” is merged into the TP with the TP-ID “TP110-IDxx.”
7) In this process, a link between the “TP111-IDxx” record and the “TP110-IDxx” record is made. The link is made in a manner to make it easy to trace the link in both upstream and downstream directions in future. Specifically, “TP110-IDxx” indicative of the master TP is appended to the phrase “merged to” in the record “TP111-IDxx.” At the same time, “TP111-IDxx” indicative of the slave TP is appended to the phrase “link from” in the record “TP110-IDxx.”
8) Further, the TP with the TP-ID “TP110-IDxx” is merged into the TP with the TP-ID “TP100-IDxx” so that a link between the two records will be made.
9) Finally, a link is made from the “TP100-IDxx” record to the product serial number “FGA-IDxx.” Thus the creation of the TP history information on the pieces with the product serial number “FGA-IDxx” is completed.

The TP history information is also created for other pieces having different product serial numbers in the same manner. The TP-ID and the like as the sources of the TP history information can be collected by attaching an RFID or the like on each TP and reading information from the RFID. Images of the parts with RFID tags attached on them and detection gates for reading the TP-IDs from the RFID tags are shown in FIG. 1.

The detection gates set for each process may be connected through wired lines or wireless channels to an apparatus for managing the TP history information. In such a structure, if each detection gate is provided with a function for sending the TP-ID, the process ID, and the transit time, its operations from detection of passing TP to recoding of TP history information can be automated.

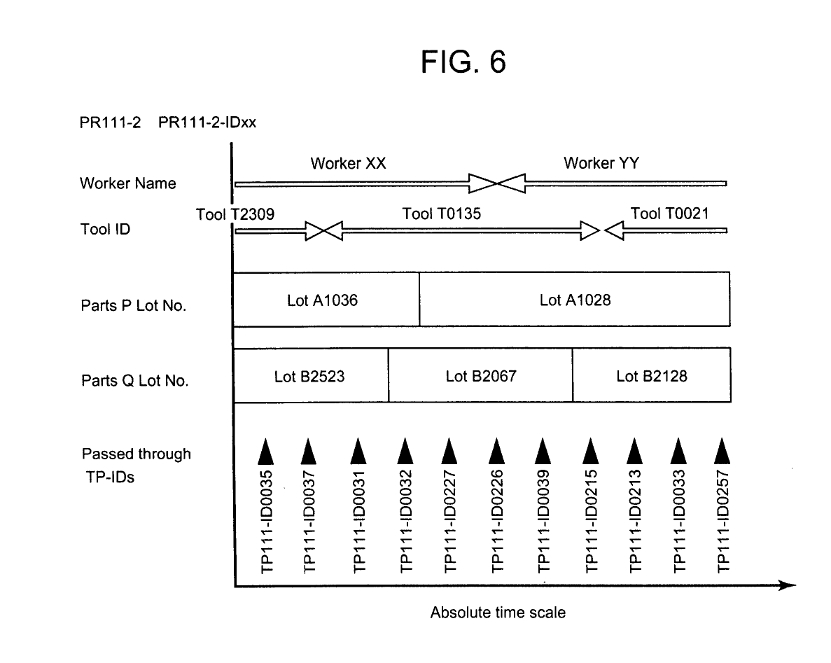

On the other hand, process control information as shown in FIG. 6 is recorded for each process. If there are two or more lines in one process, the process control information will be recorded for each individual manufacturing line. The recording method and data structure are not prescribed, but they should ideally be such that information as shown in FIG. 6 is recorded along the time axis.

FIG. 6 shows, as an example, process control information on the process “PR111-2” with the process ID “PR111-2-IDxx.” In this example, workers, shifts, IDs of used tools (machines tools, etc.), and lot numbers of parts, other than the TP, assembled in the process are recorded. As not shown in FIG. 6, workplace conditions, such as temperature and humidity, may also be recorded.

Further, the process control information keeps track of what time the master TP passed through the process in association with its TP-ID. Each record of transit has only to be made in synchronization with the timing at which the TP-ID is read in the process and written to the TP history information of FIG. 5. If the RFID system or the like is used, the record can be automatically made without the assistance of an attendant.

The TP history information on each individual product piece and the process control information on each process are accumulated as mentioned above. These pieces of information are associated with each other through each process ID, TP-ID, and time, making it possible to ensure 100 percent traceability, which has been the problem in the conventional.

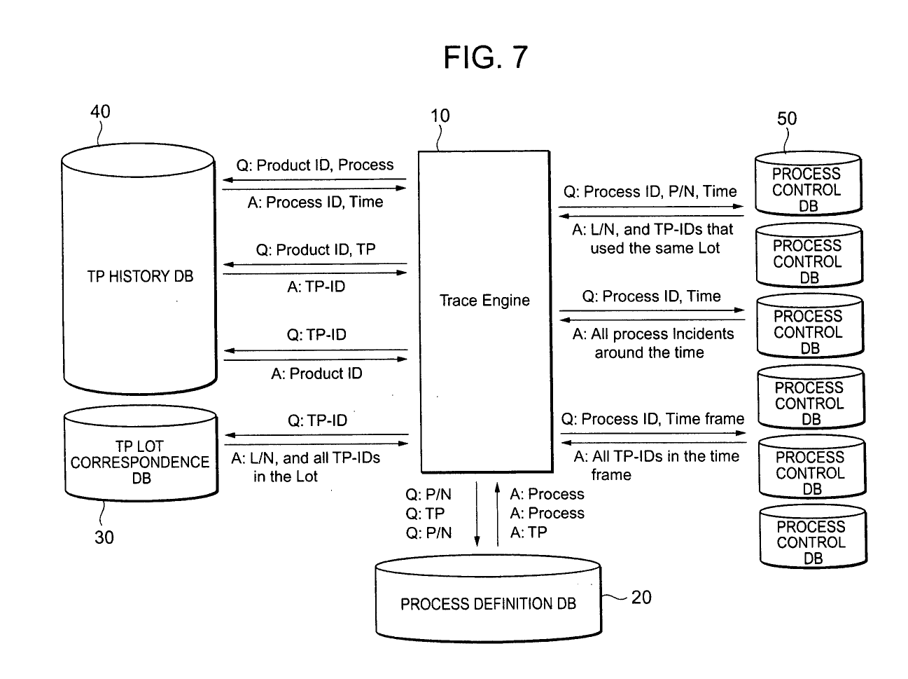

FIG. 7 is a schematic diagram showing the structure of a product tracking apparatus for realizing such traceability.

As shown in FIG. 7, the product tracking apparatus consists predominantly of a trace engine 10, a process definition database (hereinafter called “DB”) 20, a TP lot correspondence DB 30, a TP history DB 40, and a process control DB 50.

The trace engine 10 is a core engine of the product tracking apparatus; it tracks product pieces with reference to each DB.

The process definition DB 20 stores the definition of each process, such as to which leaf each part corresponds and to which node each process corresponds, in the binary tree as shown in FIG. 4.

The TP lot correspondence DB 30 stores correspondences between TP-IDs and lot numbers.

The TP history DB 40 stores the TP history information as shown in FIG. 5 for all the individual pieces of the product.

The process control DB 50 stores the process control information as shown in FIG. 6. Assuming that the process control DB 50 is created for each process ID, multiple process control DBs 50 are shown in FIG. 7. However, these DBs may be integrated into one DB.

The following gives a brief description of how to exchange information between the trace engine 10 and each DB.

The trace engine 10 exchanges information with the process definition DB 20 as follows: At first, it delivers parts information to receive process information. Secondly, it delivers parts information on TP to receive process information. Thirdly, it delivers the parts information to receive the parts information on TP.

The trace engine 10 exchanges information with the TP lot correspondence DB 30 in a way to deliver a TP-ID so as to receive a lot number and a TP-ID list of TP included in the lot.

The trace engine 10 exchanges information with the TP history DB 40 as follows: At first, it delivers a product serial number and process information to receive a process ID and time. Secondly, it delivers the product serial number and parts information on TP concerned to receive its TP-ID. Thirdly, it delivers the TP-ID to receive the product serial number.

The trace engine 10 exchanges information with the process control DB 50 as follows: At first, it delivers a process ID, parts information, and time to receive a lot number and a TP-ID list of TP passing through the process during the time period for which parts from the same lot were used. Secondly, it delivers the process ID and the time to receive information on all events occurring around the same time frame. Thirdly, it delivers the process ID and the time frame to receive a TP-ID list of all TP involved in the time frame.

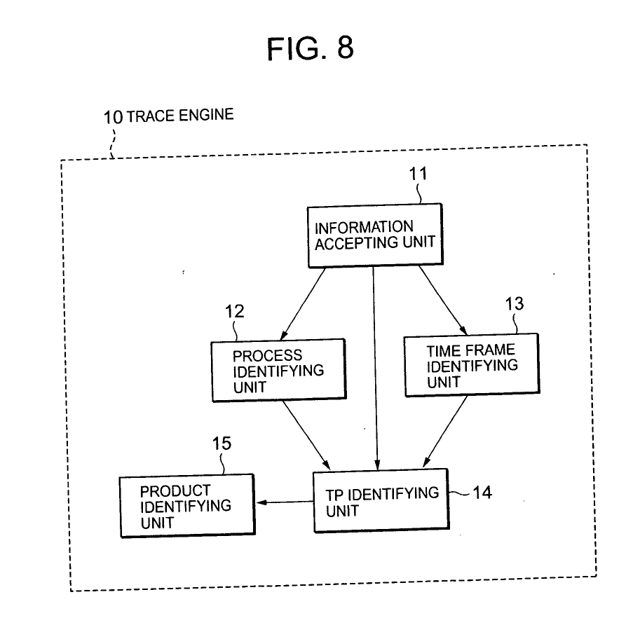

FIG. 8 shows such a functional structure of the trace engine 10.

As shown in FIG. 8, the trace engine 10 includes an information accepting unit 11, a process identifying unit 12, a time frame identifying unit 13, a TP identifying unit 14, and a product identifying unit 15.

The information accepting unit 11 accepts a product serial number and parts information on faulty parts, or a product serial number and process information on a faulty process.

When the information accepting unit 11 accepts a product serial number and parts information on faulty parts, the process identifying unit 12 consults the process definition DB 20 to identify a process in which the faulty parts were used.

The time frame identifying unit 13 identifies a time frame, during which a problem or defect occurred, during the time period for which product pieces with the product serial number passed through the process.

The TP identifying unit 14 consults the process control DB 50 to identify the TP-ID of TP passing through the process in the time frame.

The product identifying unit 15 identifies the product serial numbers of all products manufactured using the TP with the TP-ID.

The following gives a detail description of tracing processing according to the embodiment.

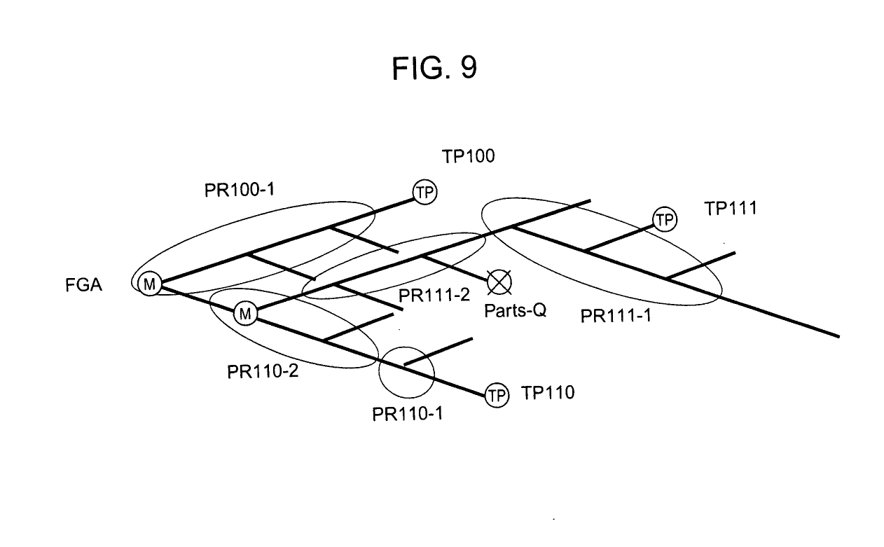

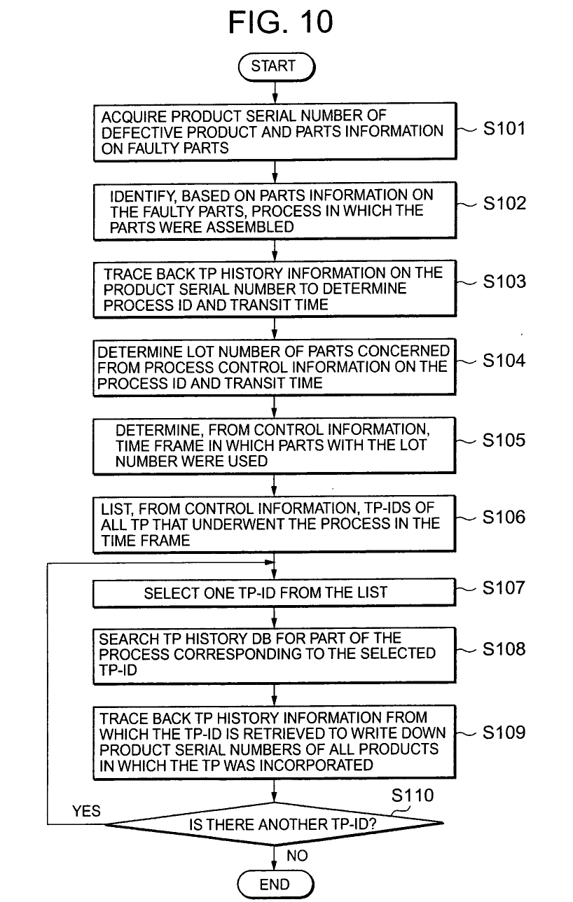

Case 1 is an example of tracing processing when the product serial number of a defective product and faulty parts (other than TP) that caused the defect are found. For example, suppose that parts Q with a cross on it in FIG. 9 is found faulty. In this case, the trace engine 10 operates as shown in FIG. 10.

First, the information accepting unit 11 accepts the product serial number of the defective product and parts information for identifying the parts that caused the defect (step 101). In the example of FIG. 9, it accepts parts information for identifying the parts Q.

Next, the process identifying unit 12 consults the process definition DB 20 to identify a process for assembling the parts identified from the parts information (step 102). In the example of FIG. 9, it identifies the process “PR 111-2” as the process for assembling the parts Q.

On the other hand, the time frame identifying unit 13 extracts TP history information on the product serial number accepted at step 101 from TP history information recorded by each product serial number in the TP history DB 40. Upon the request of the time frame identifying unit 13, the TP history DB 40 looks up for the record of the product serial number, tracing links downward until it comes to the process known in the step 102. Then, it determines the process ID of a process or a work line in the process, through which the parts Q passed, and its transit time, from the description concerning the process identified at step 102 (step 103). In the example of FIG. 9, it determines the process ID “PR111-2-IDxx” and its transit time. By going through these steps, it can be known when the parts Q was assembled in the process with the process ID “PR111-2-IDxx.”

Further, the time frame identifying unit 13 consults the process control DB 50 to retrieve information on the process ID so as to identify a lot of faulty parts used at the time determined at step 103 (step 104). In the example of FIG. 9, it obtains the lot number of a lot to which the parts Q belong, from the process control information on the process ID “PR111-2-IDxx.”

Then, it consults the process control DB 50 to retrieve a record of the process with the lot number obtained so as to identify the time frame, during which the lot was used, as a time frame during which a problem or defect occurred (step 105).

After that, the TP identifying unit 14 lists TP-IDs of all TP passing through the process in the time frame (step 106). In the example of FIG. 9, since TP passing through the process “PR111-2” is the TP “TP111,” the TP-IDs passed through PR111-2 in the time frame are listed.

Then, the product identifying unit 15 selects one TP-ID from the listed TP-IDs (step 107), and searches the TP history DB 40 using the selected TP-ID for corresponding part of the process (step 108). When the TP-ID is found, the product identifying unit 15 identifies the correspondent product serial number of the product in which the TP is incorporated, and then writes down it, for example, to a defective product serial number list (step 109). Upon the request of the product identifying unit 15, the TP history DB 40 lools up for the record including the TP-ID found in the S108, tracing links upward until it reaches the root, product serial number.

At the final step, it is determined whether another TP-ID is in the list (step 110). If there is another TP-ID, steps 107 to 109 will be repeated, while if there is no other TP-ID, the processing will end.

The above-mentioned processing makes it possible to list the product serial numbers of all products using parts from the same lot as the faulty parts.

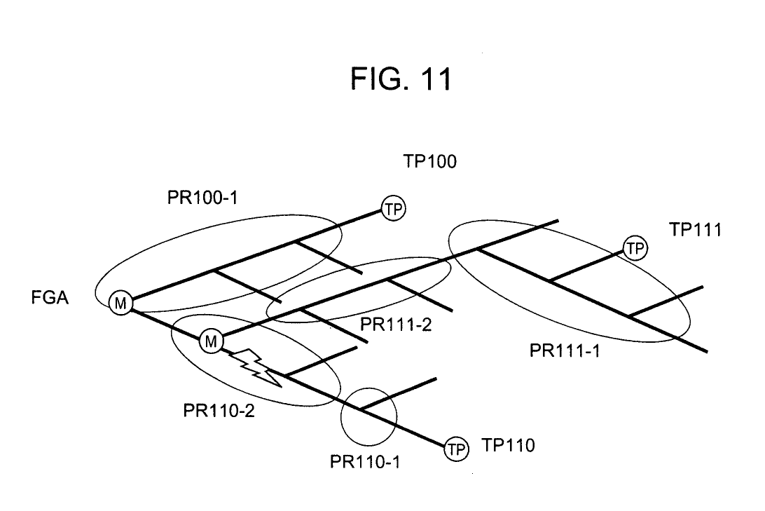

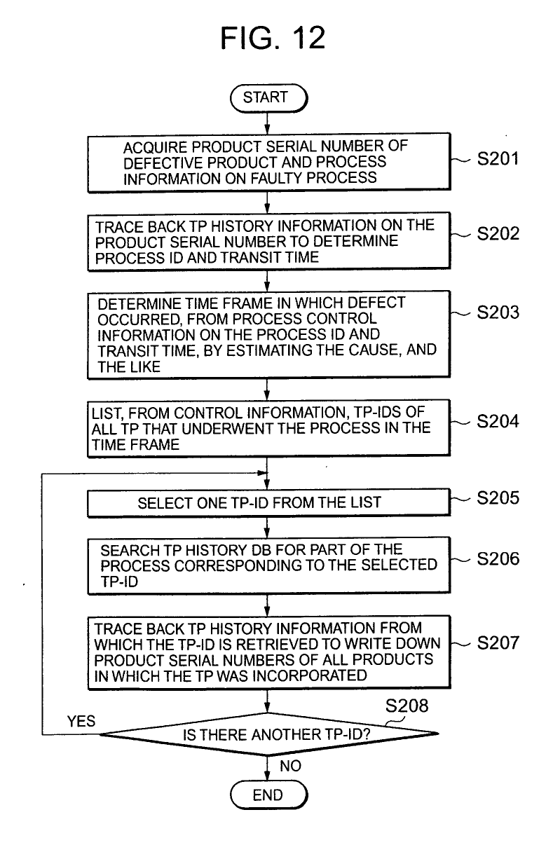

Case 2 is an example of tracing processing when the product serial number of a defective product and a faulty process that caused the defect are found. For example, suppose that the process “PR110-2” indicated by a thunder mark in FIG. 11 is found faulty. In this case, the trace engine 10 operates as shown in FIG. 12.

First, the information accepting unit 11 accepts the product serial number of the defective product and process information for identifying the process that caused the defect (step 201). In the example of FIG. 11, it accepts process information for identifying the process “PR110-2.”

On the other hand, the time frame identifying unit 13 extracts TP history information on the product serial number accepted at step 201 from TP history information recorded for each serial number in the TP history DB 40. Then, it determines the process ID of the process or a work line in the process, through which the TP passed, and its transit time (step 202). In the example of FIG. 11, it determines the process ID “PR110-2-IDxx” and its transit time. By going through these steps, it can be known when the TP “TP110” passed through the process with the process ID “PR111-2-IDxx.”

Further, the time frame identifying unit 13 consults the process control DB 50 to retrieve information on the process ID so as to analyze the cause and duration of a problem or defect in the process at the time identified at step 202 (step 203). In the example of FIG. 11, it determines a time frame, in which the problem or defect occurred, from the process control information on the process ID “PR110-2-IDxx.”

The analysis at step 203 also involves investigation and estimation of data other than those in the process control DB 50. This is because, for example, when a local coating failure was caused by a change in humidity due to a breakdown of an air conditioning system, data indicating the duration of the breakdown of the air conditioning system may have not always been recorded in the process control DB 50.

After that, the TP identifying unit 14 lists TP-IDs of all TP passing through the process in the time frame (step 204). In the example of FIG. 11, since TP passing through the process “PR110-2” is the TP “TP110,” the TP-IDs passed through PR110-2 in the time frame are listed.

Then, the product identifying unit 15 selects one TP-ID from the listed TP-IDs (step 205), and searches the TP history DB 40 using the selected TP-ID for corresponding part of the process (step 206). When the TP-ID is found, the product identifying unit 15 identifies the correspondent product serial number of the product in which the TP is incorporated, and then writes down it, for example, to a defective product serial number list (step 207). Upon the request of the product identifying unit 15, the TP history DB 40 lools up for the record including the TP-ID found in the S108, tracing links upward until it reaches the root, product serial number.

At the final step, it is determined whether another TP-ID is in the list (step 208). If there is another TP-ID, steps 205 to 207 will be repeated, while if there is no other TP-ID, the processing will end.

The above-mentioned processing makes it possible to list the product serial numbers of all products passing through the faulty process in the time frame during which the problem or defect occurred in the process.

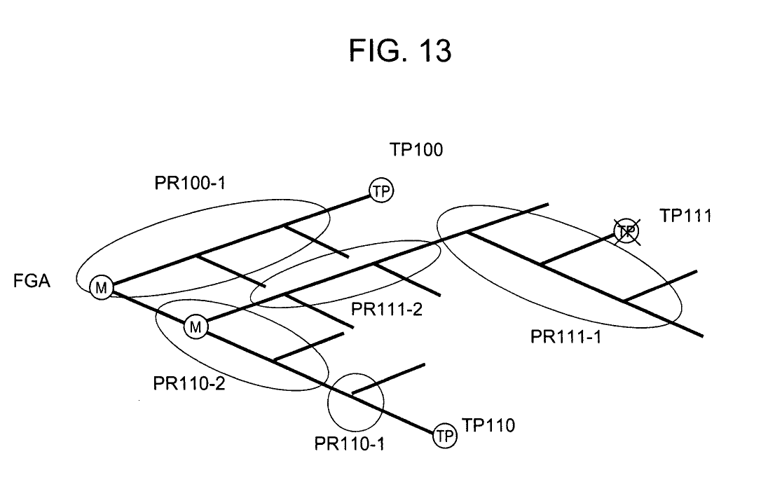

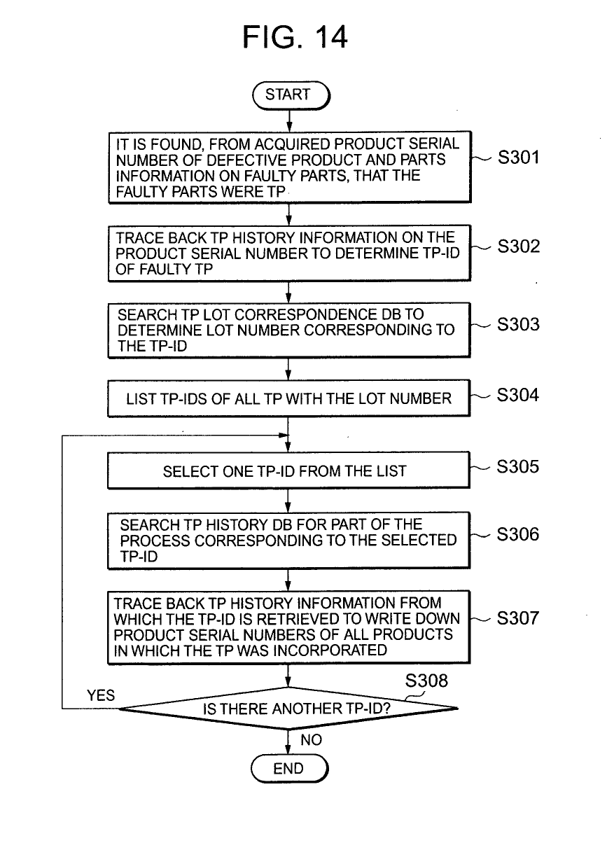

Finally, Case 3 is an example of tracing processing when the product serial number of a defective product and faulty parts (TP) that caused the defect are found. For example, suppose that the TP “TP111” with a cross on it in FIG. 13 is found faulty. In this case, the trace engine 10 operates as shown in FIG. 14.

First, the information accepting unit 11 accepts the product serial number of the defective product and parts information for identifying the parts that caused the defect (step 301). In the example of FIG. 13, it accepts parts information for identifying the TP “TP111.”

On the other hand, the time frame identifying unit 13 extracts TP history information on the product serial number accepted at step 301 from TP history information recorded for each serial number in the TP history DB 40. Then, it determines the TP-ID from the description concerning the TP identified at step 301 (step 302). In the example of FIG. 13, it determines the TP-ID “TP111-IDxx.”

The trace engine 10 consults the TP lot correspondence DB 30 to identity a lot to which the TP with the TP-ID belongs (step 303).

After that, the TP identifying unit 14 lists TP-IDs of all TP belonging to the lot identified at step 303 (step 304).

Then, the product identifying unit 15 selects one TP-ID from the listed TP-IDs (step 305), and searches the TP history DB 40 using the selected TP-ID for corresponding part of the TP (step 306). When the TP-ID is found, the product identifying unit 15 identifies the correspondent product serial number of the product in which the TP is incorporated, and then writes down it, for example, to a defective product serial number list (step 307). Upon the request of the product identifying unit 15, the TP history DB 40 lools up for the record including the TP-ID found in the S108, tracing links upward until it reaches the root, product serial number.

At the final step, it is determined whether another TP-ID is in the list (step 308). If there is another TP-ID, steps 305 to 307 will be repeated, while if there is no other TP-ID, the processing will end.

The above-mentioned processing makes it possible to list the product serial numbers of all products using the TP from the same lot as the faulty TP.

In the embodiment, only lot information on non-TP is recorded in the process control DB 50. In other words, the TP lot correspondence DB 30 is provided for recording the relationship between the TP-ID and the lot of each TP. Such a structure is based on the assumption that it would be easy to associate the TP-ID with the lot because every TP was already associated with a TP-ID in preprocessing for attaching the TP-ID on the TP. Further, since the TP are not recorded in the process control DB 50, any TP is free from the constraint that parts have to be used up on a lot basis. However, it is needless to say that the TP can be recorded in the process control DB 50, providing such a constraint that any TP is used up on a lot basis.

In the above description, the TP used for tracking products are decided on condition that all the manufacturing processes are passed through by at least one TP. The following describes an example of how to decide on the TP using a computer.

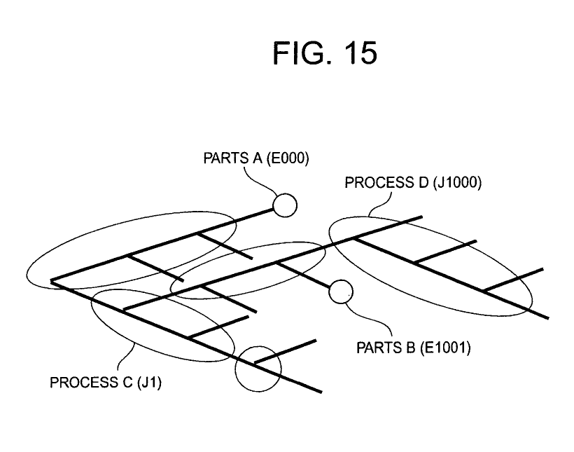

The description will be made with reference to a binary tree as shown in FIG. 15 again. In such a binary tree, all parts are associated with respective leaves and represented by character strings, each made up of a combination of “0s” and “1s.”

In other words, if upward branching in FIG. 15 is represented by “0” and downward branching by “1” on condition that the finished product is the root, parts A can be expressed as “E000” and parts B as “E1001.” Here, the letter “E” representing the word “edge” is prefixed to each binary number string to distinguish the parts name from the name of each process to be described later.

In this case, since each junction can also be represented by a character string made up of a combination of “0s” and “1s,” all the processes can be represented by character strings, each representing the most downstream junction in the process. For example, process C can be expressed as “J1” and process D as “J1000.” The letter “J” representing the word “junction” is prefixed to each binary number string to distinguish it from the parts name described above.

Thus, it is assumed in the binary tree that information for identifying a leaf corresponding to each part and information for identifying a node group corresponding to each process are stored in the process definition DB 20 as character strings created based on the above-mentioned rules. In the embodiment, a TP decision device reads the contents of the process definition DB 20 to decide on each TP efficiently.

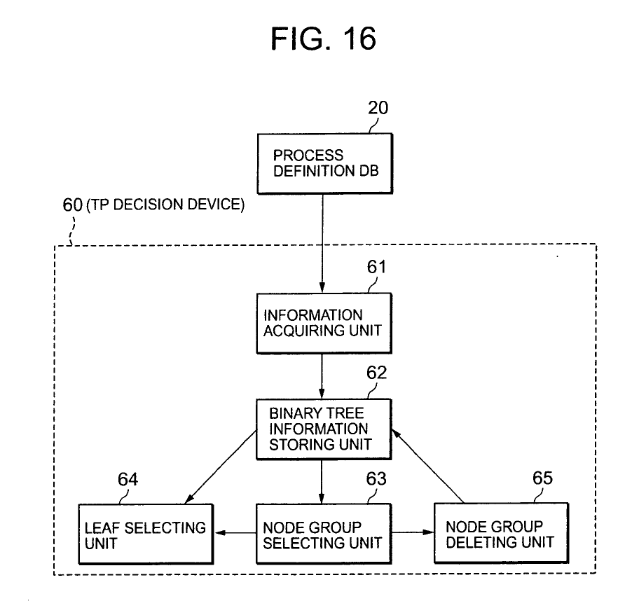

Referring next to FIG. 16, the functional structure of the TP decision device will be described.

As shown in FIG. 16, a TP decision device 60 consists predominantly of an information acquiring unit 61, a binary tree information storing unit 62, a node group selecting unit 63, a leaf selecting unit 64, and a node group deleting unit 65.

The information acquiring unit 61 acquires or creates a binary list of parts and a binary list of processes from the process definition DB 20.

The binary tree information storing unit 62 stores these lists acquired or created by the information acquiring unit 61.

The node group selecting unit 63 selects a process whose binary representation shows the largest ordinal stage number from the list of binary representations of processes stored in the binary tree information storing unit 62.

The leaf selecting unit 64 selects the binary representation of any one of parts used in the selected process from the list of binary representations of parts stored in the binary tree information storing unit 62.

The node group deleting unit 65 deletes the binary representation of the process selected by the node group selecting unit 63. It also deletes binary representations of processes from the selected process to the final process.

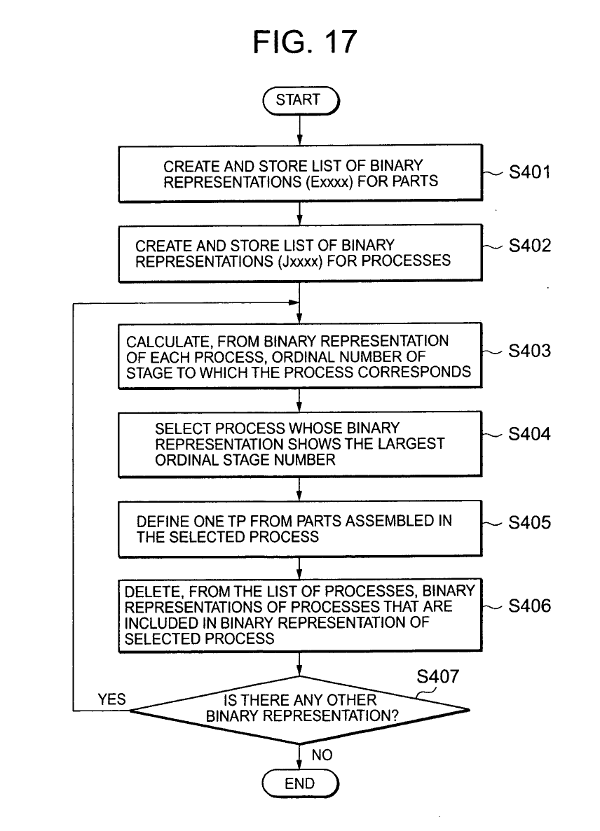

Referring next to FIG. 17, the operation of the TP decision device 60 will be described.

First, the information acquiring unit 61 acquires information for identifying a leaf corresponding to each of parts from the information stored in the process definition DB 20, and stores the acquired information in the binary tree information storing unit 62 as a list of binary representations of parts (step 401). In the case of the binary tree illustrated by an example in the specification, the list includes the following:
“E000,” “E001,” “E01,” “E10000,” “E100010,” “E1000110,” “E10000111,” “E10001,” “E101,” “E110,” “E1110,” and “E1111.”

Further, the information acquiring unit 61 acquires information for identifying a node group corresponding to each process from the information stored in the process definition DB 20, and stores the acquired information in the binary tree information storing unit 62 as a list of binary representations of processes (step 402). In the case of the binary tree illustrated by an example in the specification, the list includes the following:
“J (final process),” “J1,” “J10,” “J1000,” and “J111.”

In this example, for the sake of simplifying the description, it is assumed that the parts list includes 12 binary representations and the process list includes five binary representations. Note here that in practice both lists include a much larger number of binary representations. For example, in the case of assembly of 30,000 parts, like in the manufacture of cars, the binary representations included in the parts list amount to 30,000. Further, if one process includes eight junctions on average, the binary representations included in the process list amount to about 4,000.

Next, the node group selecting unit 63 calculates, for all the processes, the ordinal number of a stage to which each process corresponds (step 403). In other words, it calculates what stage number (that is, how manieth stage) each process is from the final process. The calculation is made by counting the number of binary representations of other processes matching the first part of the binary representation of the process for which the calculation is made.

For example, since the first part of the process “J1000” matches the processes “J10,” “J1,” and “J,” it is found that the process “J1000” is at the fourth stage. On the other hand, since the first part of the process “J111” matches the processes “J1” and “J,” it is found that the process “J111” is at the third stage.

Thus, the node group selecting unit 63 determines that the process “J (final process)” is at the first stage, the process “J1” is at the second stage, the process “J10” is at the third stage, the process “J1000” is at the fourth stage, and the process “J111” is at the third stage.

The node group selecting unit 63 selects a process at the stage with the largest ordinal number from among all the processes (step 404). It means that the selected process is the endmost process that will have no upstream process.

Then, the leaf selecting unit 64 decides on one of parts assembled in the process selected at step 404 to be the TP (step 405). If there are two or more parts assembled in the process, any one of the parts is selected with consideration given to ease of tagging a bar cord or RFID, ease of reading it in the downstream processes, etc.

In the above example, it is assumed that the process “J1000” is selected, and “E100010” is selected as TP from among the parts “E10000,” “E100010,” “E1000110,” and “E1000111.”

The parts assembled in the process are automatically listed by checking the process list against the parts list. In other words, since the process is the endmost process that will have no upstream process, four parts “E10000,” “E100010,” “E1000110,” and “E1000111,” all including the character string “1000” in their first part, are automatically identified, from the representation of the process “J1000,” as the parts assembled in the process.

Next, the node group deleting unit 65 deletes, from the process list, the binary representation of the process selected at step 404, and the binary descriptions of all the processes matching the first part of the binary representation of the process (step 406). This is because these processes are passed through by the TP decided on at step 405.

After that, it is determined whether any other binary representation remains in the process list (step 407). If any other binary representation remains, steps 403 to 406 are repeated.

In the above example, the process “J111” remains in the process list after the binary representations of the other processes are deleted. Therefore, the node group selecting unit 63 recalculates the ordinal stage number of each process in the process list consisting only of the process “J111” (step 403). The recalculation is made by counting the number of binary representations of other processes matching the first part of the binary representation of the process for which the calculation is made. As a result of recalculation, it is found that the process “J111” is at the first stage. Further, at step 404, the process “J111” is selected as the process whose binary representation shows the largest ordinal stage number. Then, at step 405, “E1111” assembled in the process “J111” is decided on to be the TP. In this example, since the number of parts and the number of processes are much smaller than in a practical situation, only one process remains at this stage. However, since only the processes through which the decided TP passed are deleted, the processes deleted at this stage are considered to be only a small fraction of all the processes in the practical situation.

As a result of determination at step 407, if no binary representation remains, the processing will end. At this point in time, all necessary TP have been decided. It ensures that all the processes were passed through by any of the TP. In the above example, it is determined that all the processes were passed through by either the TP “E100010” or the TP “E1111.” The parts “E1000” may also be added as the TP as shown in FIG. 4.

If there are two or more processes are at the same stage, thought the problem of which process should be selected remains unsolved, any process may be selected.

The basic rule of merging TP is that the TP decided on later is merged into the TP decided on earlier. This rule is based on the fact that a reduction in the number of TP covering many stages is effective in view of the mounting of RFID tags or the like. Any exception, of course, can be thrown. For example, it can be arbitrarily selected which one should be merged into the other in the context of the actual situation.

Finally, a description will be given of the hardware structure of the apparatus for recording TP history information and process control information, the product tracking apparatus, and the TP decision device.

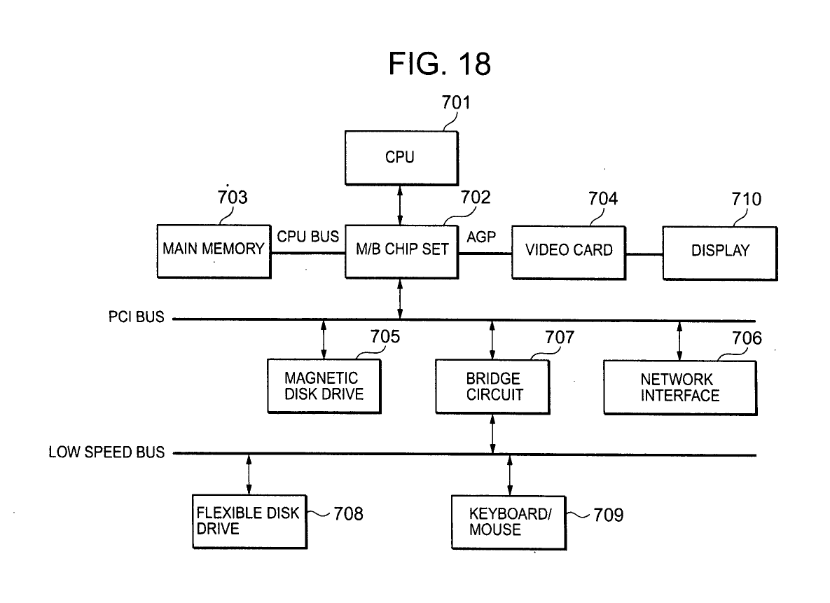

FIG. 18 schematically shows the hardware structure of a computer suitable for implementing the functions of these apparatuses.

The computer shown in FIG. 18 includes a CPU (Central Processing Unit) 701 as computation means, an M/B (Mother Board) chip set 702, a main memory 103 connected to the CPU 701 through the M/B chip set 702 and a CPU bus, and a video card 704 and a display 710 connected to the CPU 701 through the M/B chip set 702 and an AGP (Accelerated Graphics Port). It also includes a magnetic disk drive (HDD) 705 and a network interface 706, both connected to the M/B chip set 702 through a PCI (Peripheral Component Interconnect) bus. It further includes a flexible disk drive 708 and keyboard/mouse 709, both connected to the M/B chip set 702 through the PCI bus via a bridge circuit 707 and a low-speed bus such as an ISA (Industry Standard Architecture) bus.

FIG. 18 just illustrates the hardware structure of the computer used to implement the embodiment, and any other various configurations can be taken as long as they are applicable to the embodiment. For example, only a video memory may be mounted instead of the video card 704 so that the CPU 701 will process image data. An external storage, such as a CD-R (Compact Disc Recordable) or DVD-RAM (Digital Versatile Disc Random Access Memory) drive, may also be provided through an interface such as an ATA (AT Attachment) or SCSI (Small Computer System Interface).

As described above, according to the embodiment, there are provided the TP history DB storing established correspondences between the product serial numbers of products and TP-IDs of TP, and the process control DB for managing the transit time of each TP in each process using the TP-ID of the TP. Then, when the serial number of a defective product and faulty parts or a faulty process are found, these DBs are consulted to identify the serial numbers of products to be recalled. This makes it possible to select only real recall targets rather than selecting all products suspected.

Further, in the embodiment, the TP decision device is provided to decide on such a minimum set of TP that all the processes would be passed through by at least one TP. The use of such a device can further save labor of tracking products.

Although the above embodiment was described with machine products like cars in mind, the present invention is applicable any other products consisting of multiple components. In such a case, the present invention can be understood by reading the above embodiment in such a way that the word “parts” is replaced with the word “components” and the word “TP” that means the phase “traced parts” is replaced with the phrase “traced components.”

1. An apparatus for tracking products, each consisting of multiple parts, comprising:
a first database storing first information for identifying some of the multiple traced parts predetermined as an element for future tracking of a particular product;
a second database storing second information for identifying each traced part passing through each process of manufacturing the product and its transit time;
traced part identifying means for identifying a traced part passing through a particular process in a particular time frame by referring to the second information stored in said second database; and
product identifying means for identifying particular products manufactured using the traced part identified by said traced part identifying means.

2. The apparatus according to claim 1, further comprising:
a third database storing process definition information defining correspondences between the manufacturing processes of the product and parts of the product used in the manufacturing processes; and
manufacturing process identifying means for searching said third database based on input information including identification information on the particular product and identification information on the parts that caused a problem or defect to identify a particular manufacturing process.

3. The apparatus according to claim 1, wherein
said first database also stores information for identifying the time at which each product passed through each manufacturing process, and
said apparatus further comprises time frame identifying means for searching the first database based on input information including identification information of the particular product to identify a particular time frame based on the usage conditions of parts lots at the time.

4. The apparatus according to claim 1, wherein
said first database also stores information for identifying the time at which each product passed through each manufacturing process, and
said apparatus further comprises time frame identifying means for searching the first database based on input information including identification information of the particular product to identify a particular time frame based on the duration of the work environment at the time.

5. The apparatus according to claim 1 further comprising:
a fourth database storing lot information for identifying a lot to which the traced part belongs; and
acceptance means for accepting identification information for identifying parts that caused a problem or defect in the particular product, wherein
when the parts identified from the identification information accepted by said acceptance means are the traced part, said traced part identifying means identifies the other traced parts belonging to the same lot as the traced part by referring to the lot information stored in said fourth database.

6. The apparatus according to claim 1 wherein the traced part is decided on such condition that each of the processes for manufacturing the product would have been passed through by at least one traced part.

7. The apparatus according to claim 6 wherein the traced part is decided on using a binary tree defining a finished product as the root and each part as a leaf.

8. An apparatus for tracking products, each consisting of multiple parts, comprising:
a first recording unit for recording identification information on each of parts (traced parts) predetermined as an element for future tracking of a particular product, and the time at which each traced part passed through a particular process for manufacturing the product; and
a second recording unit for recording identification information on each of products using the traced part in association with the identification information on the traced part.

9. The apparatus according to claim 8 wherein
when two different traced parts were assembled in a certain process, said first recording unit records identification information on the first traced part, the time at which the first traced part passed through the process, and information for associating the second traced part with the first traced part.

10. The apparatus according to claim 8 wherein the traced part is decided on such condition that each of the processes for manufacturing the product would have been passed through by at least one traced part.

11. A method of tracking products, each consisting of multiple parts, comprising the steps of:
storing, in a first database, first information for identifying each of traced parts predetermined as an element for future tracking of a particular product;
storing, in a second database, second information for identifying each traced part passing through each process for manufacturing the product and its transit time;
identifying a traced part passing through a particular manufacturing process in a particular time frame by referring to the second information stored in the second database; and
identifying particular products manufactured using the identified traced part by referring to the first information stored in the first database.

12. The method according to claim 11 further comprising the steps of:
storing, in a third database, process definition information defining correspondences between the manufacturing processes of the product and parts of the product used in the manufacturing processes; and
searching the third database based on input information including identification information on the particular product and identification information on the parts that caused a problem or defect to decide on a particular manufacturing process.

13. The method according to claim 11 wherein
in said step of storing information in the first database, information for identifying the time at which each traced part for each product passed through each manufacturing process, and
said step of identifying the traced part further comprises
a step of accepting identification information on the particular product, and
a step of searching the first data base to determine the time at which the particular product passed through the particular manufacturing process so as to decide on a particular time frame based on the usage conditions of parts lots at the time.

14. The method according to claim 11 wherein
in said step of storing information in the first database, information for identifying the time at which each traced part for each product passed through each manufacturing process, and
said step of identifying the traced part further comprises
a step of accepting identification information on the particular product, and
a step of searching the first data base to determine the time at which the particular product passed through the particular manufacturing process so as to decide on a particular time frame based on the duration of the work environment at the time.

15. The method according to claim 11 further comprising the steps of:
storing, in a fourth database, lot information for identifying a lot to which each traced part belongs; and
accepting identification information for identifying parts that caused a problem or defect in the particular product, wherein
when the parts identified from the identification information accepted in said acceptance step are the traced part, the other traced parts belonging to the same lot as the traced part are identified in said traced part identifying step by referring to the lot information stored in the fourth database.

16. The method according to claim 11 wherein the traced part is decided on such condition that each of the processes for manufacturing the product would have been passed through by at least one traced part.

17. The method according to claim 16 wherein the traced part is decided on using a binary tree defining a finished product as the root and each part as a leaf.
